(19) United States
(12) Patent Application Publication
(10) Pub. No.: US 2004/0036860 A1
(43) Pub. Date: Feb. 26, 2004

(54) Method and apparatus for defect inspection of phase shifting masks

(75) Inventor: Kouji Hiruta, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Fujitsu Limited, Kawasaki (JP)

(21) Appl. No.: 10/642,691

(22) Filed: Aug. 19, 2003

(30) Foreign Application Priority Data
Aug. 21, 2002 (JP) 2002-240750

(51) Int. Cl. G01N 21/88

(52) U.S. Cl. 356/237.1

(57) ABSTRACT

At least two (2) inspection light beams 8 are caused to penetrate through a first and a second light beam penetrating portions having the same phase of a phase shifting mask and again penetrate through the light beam penetrating portions using a reflector 3. The intensities of the reflected light beams from them are compared to each other and a defect inspection of the phase shifting mask is conducted using the intensity difference.

### CROSS-REFERENCE TO RELATED APPLICATIONS

This application is based upon and claims the benefit of priority from the prior Japanese Patent Application No. 2002-240750, filed on Aug. 21, 2002, the entire contents of which are incorporated herein by reference.

### BACKGROUND OF THE INVENTION

1. Field of the Invention

The present invention relates generally to a defect inspection of photomasks for use in photolithography, and more particularly to a method for detecting defects of phase shifting masks and to an apparatus for inspecting defects of phase shifting masks.

2. Description of the Related Arts

Photolithography is a method in which a mask is reduction-injected on a semiconductor wafer through a reduction lens to transfer the mask circuit pattern onto a photoresist layer etc. This photolithography technique is widely used in fabricating semiconductor devices.

It is necessary for the conventional masks to have been inspected their pattern defects before they are used in production such that the correct patterns are transferred. Conventional pattern defect inspection apparatuses have mainly detected defects created by chipping or remaining of shading films.

FIGS. 4(a) and 4(b) illustrate a conventional inspection method of mask defects.

FIG. 4(a) illustrates a method in which light beams are respectively injected into a reference pattern 23 and a pattern to be inspected 24 which is an inspection object and pattern defects are detected by detecting penetrating light beams 25 and comparing the intensities of the light beams 25 to each other. When there is a chipping defect 26 in which any shading film 2 is present in the pattern to be inspected 24, the chipping defect 26 is detected by comparing the penetrating light beams 25 to each other because a light beam penetrates through portions where the light beam should not penetrate originally.

In FIG. 4(b), light beams are injected into the reference pattern 23 without any defects and the pattern to be inspected 24 which is the inspection object and defects are detected by detecting reflected light beams 28 from the shading film 2 and detecting the intensity difference of the reflected light beams between the reference pattern 23 and the pattern to be inspected 24. When there is a residual defect 27 that should not be present there, the residual defect 27 is detected due to the presence of an irregular reflected light beam that should not be detected originally.

In recent years, a method is widely known, in which the edge portion of a pattern after an exposure can be made sharper by using a phase shifting mask instead of these conventional masks.

FIG. 5 is a cross-sectional view showing the structure of a phase shifting mask. In FIG. 5, the phase shifting mask consists of a mask substrate 1 consisting of quartz or SOG (Silicon On Glass) etc., a shading film 2 made from a chrome film etc., a phase-180° shifter portion 4 and a phase-0° portion 5. Strictly speaking, no phase shifting occurs in the phase-0° portion 5. However, it is herein referred to as “phase-0° portion” or “phase-0° shifter” to simplify the explanation. The phase-180° shifter portion 4 shown is the one which has been formed by etching quartz etc. The phase shifting mask may be the one formed by stacking quartz etc. on the mask substrate.

In the phase shifting mask, the phase-180° shifter portion 4 and the phase-0° portion 5 are formed alternately sandwiching the shading film 2, forming a regular pattern.

FIG. 6 is a cross-sectional view showing defects in the phase shifting mask. In the phase shifting mask, openings (light-penetrating portion) of the pattern is made from quartz or SOG. Therefore, a protrusion defect 6 in the phase-180° shifter portion 4 that is a defect constituted by a protrusion of quartz or SOG, or a chipping defect 7 in the phase-0° portion 5 that is formed by chipping of quartz or SOG maybe present. Therefore, pattern defect inspections of phase shift masks are necessary.

However, in the case of phase shifting masks, the conventional chipping defect 26 and the residual defect 27 of the shading film 2 shown in FIG. 4 can be detected in the conventional method for mask defect inspection. However, there has been a problem that the protrusion defect 6 in the phase-180° shifter portion 4 or a chipping defect 7 in the phase-0° portion 5 described above can not be detected in the conventional method for mask defect inspection.

The reason for the above is that, in the conventional method for defect inspection using penetrating light beams, whether there is a defect or not can not be judged because a penetrating light beam 25 occurs in both of defected portions and normal portions without any defect. Furthermore, in the conventional method for defect inspection using reflected light beams, whether there is a defect or not also can not be judged because no reflected light beams occur in both of defected portions and normal portions without any defect.

### SUMMARY OF THE INVENTION

It is therefore the object of the present invention to provide a method and an apparatus for defect inspection of phase shifting masks, that can inspect defects in phase shifting masks.

In order to achieve the above object, a first aspect of the present invention is characterized in that it comprises injecting light beams having a predetermined light beam intensity into at least a first and a second light beam penetrating portions of the phase shifting mask; reflecting the light beams having penetrated the light beam penetrating portions, by use of reflecting means, to cause the light beams to again penetrate through the light beam penetrating portions; and comparing the intensities of the light beams having again penetrated the light beam penetrating portions to detect defects of the phase shifting mask.

To attain the above object, a second aspect of the present invention is characterized in that it comprises a first step of injecting light beams having a predetermined light beam intensity into a first and a second light beam penetrating portions having a first phase of the phase shifting mask, reflecting the light beams having penetrated the light beam penetrating portions, by use of reflecting means, to cause the light beams to again penetrate through the light beam penetrating portions; and comparing the intensities of the light beams having again penetrated the light beam penetrating portions to detect defects of the phase shifting mask; and a second step of injecting the light beams into a first and a second light beam penetrating portions having a second phase of the phase shifting mask, reflecting the light beams having penetrated the light beam penetrating portions, by use of reflecting means, to cause the light beams to again penetrate through the light beam penetrating portions; and comparing the intensities of the light beams having again penetrated the light beam penetrating portions to detect defects of the phase shifting mask.

Furthermore, a third aspect of the invention relates to an apparatus for implementing the above two aspects of the invention.

### BRIEF DESCRIPTION OF THE DRAWINGS

The above and other objects, aspects, features and advantages of the present invention will become more apparent from the following detailed description when taken in conjunction with the accompanying drawings, in which:

FIGS. 1(a) and 1(b) illustrate a method for inspecting defects of phase shifting masks according to a first embodiment;

FIG. 2 illustrates a method for inspecting a defect of a phase shifting mask according to a second embodiment;

FIG. 3 illustrates a phase shifting mask defect inspection apparatus according to a third embodiment;

FIGS. 4(a) and 4(b) illustrate a conventional inspection method of mask defects;

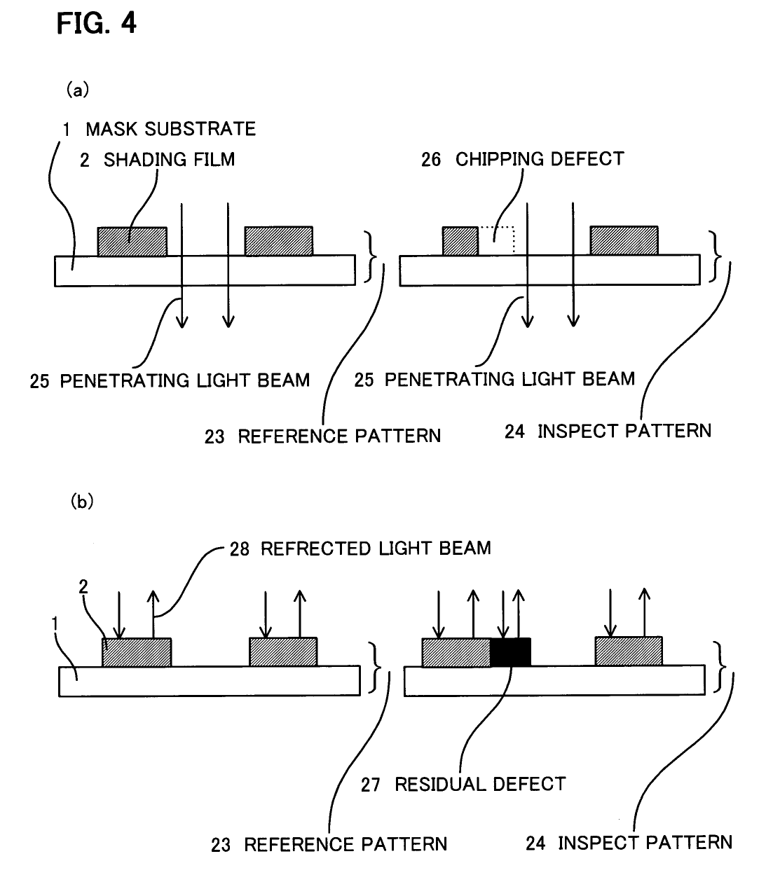

FIG. 5 is a cross-sectional view showing the structure of a phase shifting mask; and

FIG. 6 is a cross-sectional view showing defects in the phase shifting mask.

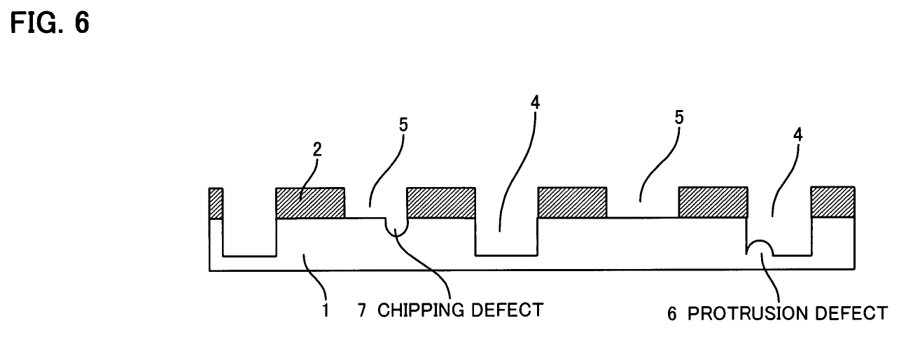

### DESCRIPTION OF THE PREFERRED EMBODIMENTS

Exemplary embodiments of the invention will now be described with reference to the accompanying drawings. It is however to be noted that the scope of the invention is not limited to the following exemplary embodiments but covers the invention defined in the appended claims and the equivalents thereof.

<First Embodiment>

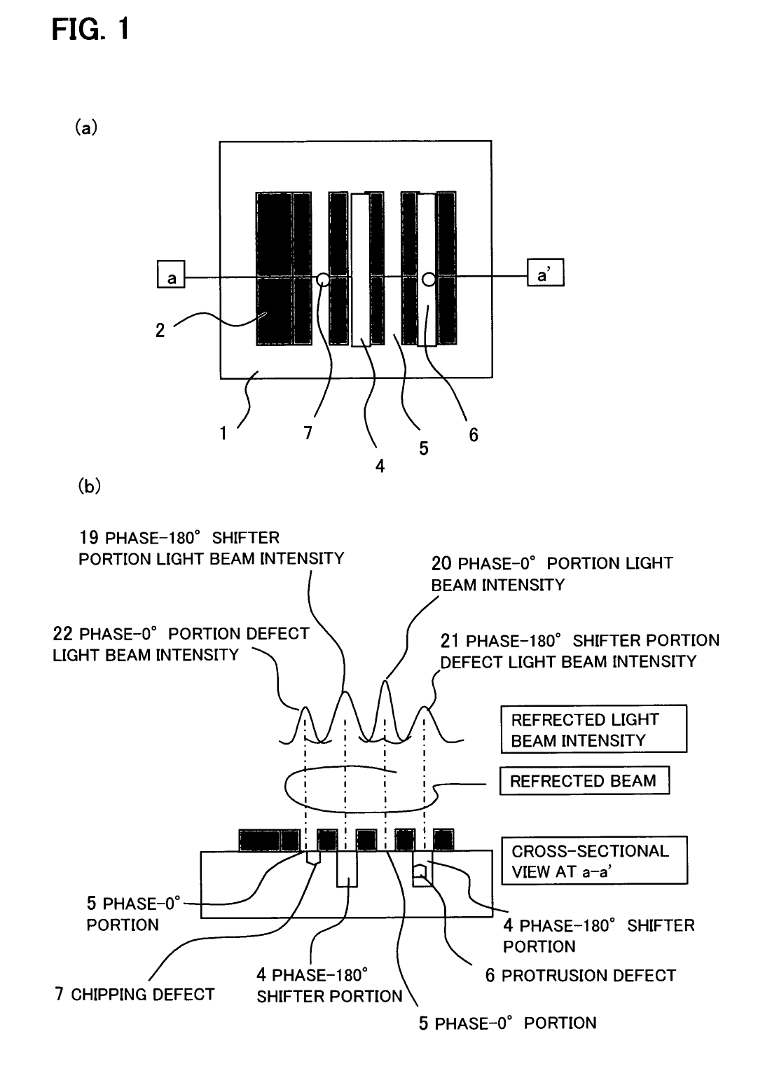

FIGS. 1(a) and 1(b) illustrate the method for inspecting defects of phase shifting masks according to a first embodiment. FIG. 1(a) is a plan view in which a phase shifting mask is observed from above and FIG. 1(b) is a cross-sectional view at a-a′in FIG. 1(a) showing the phase shifting mask.

In FIG. 1(a), the phase shifting mask consists of the mask substrate 1, the shading portion 2, the phase-180° shifter portion 4 and the phase-0° portion 5. When, for example, the protrusion defect 6 is in the phase-180° shifter portion 4 and the chipping defect 7 is in the phase-0° portion 5 in this phase shifting mask, a method for detecting those defects will be described.

In FIG. 1(b), intensities of reflected light beams reflected by a reflecting means not shown are shown. It is indicated that a light beam intensity becomes higher as a peak becomes higher. Since both of a phase-180° shifter portion light beam intensity 19 and a phase-0° portion light beam intensity 20 have no defect, it is understood that they have high peaks and their reflected light beam intensities are high.

On the other hand, a phase-180° shifter portion defect light beam intensity 21 and a phase-0° portion defect light beam intensity 22 have lower peaks and their light beam intensities are low compared to defect-free portion light beam intensities 19 and 20.

The reason for the above is as follows. Injected light beams are dispersed by the protrusion defect 6 in the phase-180° shifter portion 4 and the chipping defect 7 in the phase-0° portion 5 and their intensities are attenuated. Then, these light beams are further reflected by the reflecting means not shown and, while penetrating again through the portions with defects, they are dispersed again and their intensities are attenuated again. Therefore, the detected intensities of the reflected light beams are lowered.

As described above, defects of a phase shifting mask can be detected by utilizing the fact that light beams are dispersed after they have been injected and reflected and their intensities are attenuated, then, the detected intensities of the reflected light beams are lowered.

Furthermore, the phase-0° portion defect light beam intensity 22 and the phase-180° shifter portion light beam intensity 19 will be compared. Since the phase-0° portion defect light beam intensity 22 is attenuated because the light beam has been dispersed twice when it has been injected and reflected, the light beam intensity 22 is lower comparing to the phase-180° shifter portion light beam intensity 19. In this manner, by detecting that the intensity of reflected light beam is lowered, the presence of a defect which attenuates the light beam intensity can be detected. That is, it can be detected that a defect is present at the phase-0° portion 5 where the light beam intensity 22 is detected.

Similarly, the phase-0° portion light beam intensity 20 and the phase-180° shifter portion defect light beam intensity 21 will be compared. In this case, the phase-180° shifter portion defect light beam intensity 21 also has a lower reflected light intensity compared to the phase-0° portion light beam intensity 20. Therefore, it can be detected that a defect is present at the phase-180° shifter portion 4 where a light beam intensity 21 is detected.

As described above, a defect can be detected even when the phases of the light penetrating portions are different.

Therefore, in the first embodiment, in FIG. 1(b), light beams are injected into and penetrat through a first and a second light beam penetrating portions where any shading film 2 is not formed, and the light beams having penetrated those portions are reflected by using a reflecting means not shown such as, for example, a reflector or a board having a high surface reflectance. The reflected light beams penetrate the light beam penetrating portion again and their reflected light beam intensities are detected. A defect can be detected as described above by comparing the first and the second reflected light beam intensities.

<Second Embodiment>

In FIG. 1(b), even for same defect-free light beam penetrating portions, the phase-180° shifter portion light beam intensity 19 is somewhat lower than the phase-0° portion light beam intensity 20. This is because a dispersion of light beams is created by a slot for phase shifting formed in the phase-180° shifter portion 4 and the phase-180° shifter portion light beam intensity is lowered. Similarly, even for same defected light beam penetrating portions, a defect in the phase-180° portion and a defect in the phase-0° portion make a difference between their light beam intensities.

Now, the phase-180° defect-free shifter portion light beam intensity 19 and the phase-0° defect portion light beam intensity 22 will be compared. Though the phase-180° shifter portion has no defect, the light beam is dispersed and the light beam intensity is somewhat lowered. Since the reflected light beam intensity from the phase-0° defect portion is also low, the difference between the light beam intensities from the defected portion and defect-free portion produced depending on whether a defect is present or not is not so large. Therefore, the difference of the light beam intensities produced depending on whether a defect is present or not is large and the accuracy becomes higher when the reflected light beam intensities are compared between the reflected light beams from the light beam penetrating portions having the same phase. The method for the above will be described.

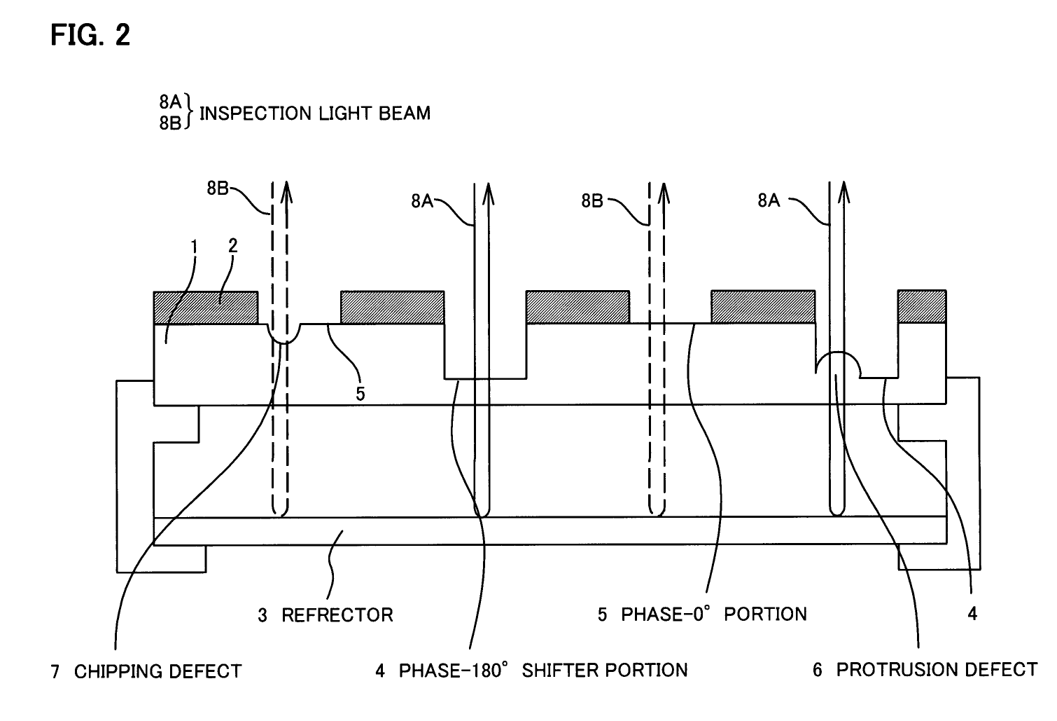

FIG. 2 illustrates a method for inspecting a defect of a phase shifting mask according to a second embodiment.

For example, when two (2) inspection light beams 8A indicated by solid lines have been injected respectively into the phase-180° shifter portion 4 and the phase-180° shifter portion 4 having the protrusion defect 6, each of the beams 8A are detected respectively as a reflected light beam intensity from the phase-180° shifter portion 4 and a reflected light beam intensity having passed twice the protrusion defect 6 in the phase-180° shifter portion 4. Comparing these reflected light beam intensities, a difference can be found between the reflected light beam intensities because one the light beams has been dispersed by the defect portion and its intensity has been attenuated. That is, since the intensity of the reflected light beam that has penetrated twice the protrusion defect 6 in the phase-180° shifter portion 4 is lowered considerably compared to the reflected light beam intensity that has penetrated the defect-free phase-180° shifter portion 4, the defect can be detected.

Similarly, when inspection light beams 8B indicated by dotted lines have been injected respectively into the phase-0° portion 5 and the phase-0° portion 5 having the chipping defect 7, each of the beams 8B are detected respectively as a reflected light beam intensity from the phase-0° portion 5 and a reflected light beam intensity having passed twice the chipping defect 7 in the phase-0° portion 5. Comparing these reflected light beam intensities, a difference can be found between the reflected light beam intensities because one the light beams has been dispersed by the defect portion and its intensity has been attenuated. Since the intensity of the reflected light beam that has penetrated the defect portion is lowered considerably compared to the reflected light beam intensity that has penetrated the defect-free portion, the defect can be detected.

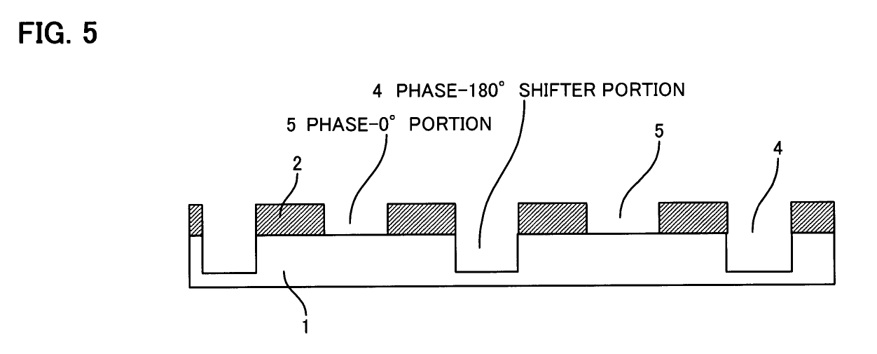

In the phase shifting mask, as shown in FIG. 5, the phase-180° portion 4 and the phase-0° portion 5 are alternately and regularly arranged sandwiching the shading film 2. Therefore, it is efficient to inspect shifting one after another pairs of light beam penetrating portions having the same phase to detect defects when inspecting throughout a phase shifting mask.

In other words, exposures of light to the first and the second light beam penetrating portions having a first phase and exposures of light to the first and the second light beam penetrating portions having a second phase are repeated alternately scanning the mask, the reflected light beam intensities from the first and the second light beam penetrating portions each having the first phase are compared and, then, the reflected light beam intensities from the first and the second light beam penetrating portions having the second phase are compared. Scanning manner maybe moving the light source for exposures or moving the phase shifting mask.

According to this method, the accuracy of defect detection can be improved because the phases of the first and the second light beam penetrating portions are same and dispersion conditions of the reflected light beam intensities to be compared become equal and, at the same time, defects can be detected efficiently by scanning the mask.

Furthermore, defects of a phase shifting mask can also be detected in a method described as follows as another method for the cases in which there is a phase shifting mask that has no defect and is same as the phase shifting mask to be inspected or it is known that there is no defect in light beam penetrating portions having a predetermined phase.

It is a defect inspection method in which, first, a light beam having a predetermined light beam intensity is radiated to and penetrated through a normal portion having a first phase of a phase shifting mask. It is again penetrated through the normal portion using a reflector 3 and its reflected light beam intensity is measured in advance as a illumination light beam intensity.

Next, the light beam is penetrated through a portion having the first phase, to be inspected and not yet inspected and the light beam penetrated through the portion to be inspected and not yet inspected is reflected by the reflector 3 and is penetrated again through the portion to be inspected and not yet inspected. Then, defects are detected by comparing the intensity of the light beam having penetrated again to the illumination light beam intensity measured in advance. In this method, defects of a phase shifting mask can be efficiently detected by scanning the portions to be inspected and not yet inspected.

<Third Embodiment>

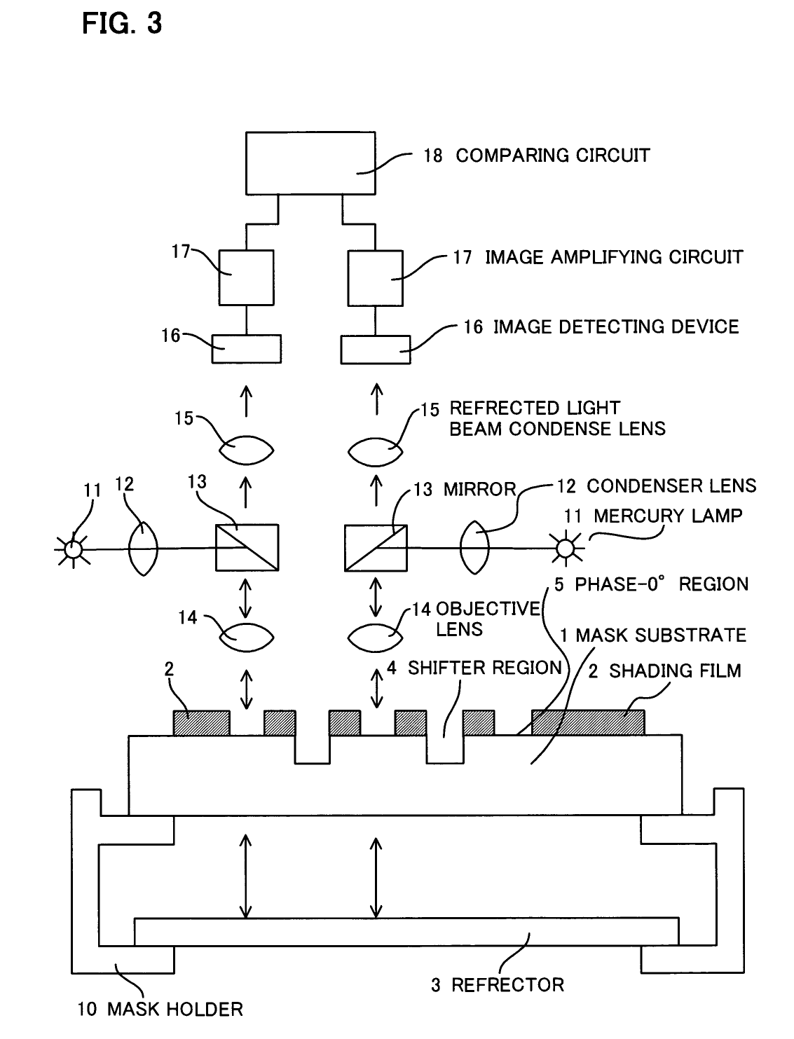

FIG. 3 illustrates a phase shifting mask defect inspection apparatus according to a third embodiment. In FIG. 3, for example, a mercury lamp 11 is used as a light source radiating light beams for exposure. The light beam radiated from the mercury lamp 11 propagates through a condenser lens 12, its optical path is changed by a mirror 13 and it is collected by an objective lens 14. The collected light beam is injected vertically into the mask substrate 1.

The mask substrate 1 consists of the shading film 2 and the light beam penetrating portion made from, for example, quartz, i.e. the phase-0° portion 5 and the phase-180° shifter portion 4. Thelight beam injected into the mask substrate reflects against the shading film 2, condensed by a reflected light beam condenser lens 15 and received by an image detecting device 16.

On the other hand, the light beam injected into light beam penetrating portion penetrates the mask substrate 1 and reflected by a reflector 3 to be a reflected light beam. This reflected light beam penetrates the mask substrate 1 from its back, is condensed by another reflected light beam condenser lens 15 and received by another image detecting device 16.

As shown in FIG. 3, this exemplary defect inspection apparatus has two (2) optical systems as described above and output signals of the image detecting devices 16 are read out one after another and supplied to a comparing circuit 18 through image amplifying circuits 17. In the comparing circuit 18, the intensities of the reflected light beams are compared to each other and a defect detection signal is output. As described above, defects of a phase shifting mask can be detected using two (2) optical systems.

The above optical systems may be replaced with one optical system. When it is know in advance that the light beam penetrating portion has no defect, a defect detection signal is also output by storing the intensity of the reflected light beam from the normal light beam penetrating portion in the comparing circuit 18 and comparing this illumination light beam intensity and the reflected light beam intensity from a light beam penetrating portion to be inspected and not yet inspected to each other.

In this embodiment, the light source is a mercury lamp. However, other light sources such as, for example, a xenon lamp may be used. An optical system using other than mirrors such as, for example, optical fibers can be used for the exposure of light to the mask.

The image detecting devices 16, the image amplifying circuits 17 and the comparing circuit 18 are all separate in this embodiment, however, these components may be arranged as one component.

As set forth hereinabove, according to the invention, it is possible to inspect accurately defects in shifter portions of aphase shifting mask. Furthermore, it is also possible to obtain easily a defect inspection apparatus for phase shifting masks having a simple constitution.

While the illustrative and presently preferred embodiments of the present invention have been described in detail herein, it is to be understood that the inventive concepts may be otherwise variously embodied and employed and that the appended claims are intended to be construed to include such variations except insofar as limited by the prior art.

What is claimed is:

1. A method for defect inspection of a phase shifting mask, comprising:
injecting light beams having a predetermined light beam intensity into at least a first and a second light beam penetrating portions of the phase shifting mask;
reflecting the light beams having penetrated the light beam penetrating portions, by use of reflecting means, to cause the light beams to again penetrate through the light beam penetrating portions; and
comparing the intensities of the light beams having again penetrated the light beam penetrating portions to detect defects of the phase shifting mask.

2. A method for defect inspection of a phase shifting mask, comprising:
a first step of injecting light beams having a predetermined light beam intensity into a first and a second light beam penetrating portions having a first phase of the phase shifting mask, reflecting the light beams having penetrated the light beam penetrating portions, by use of reflecting means, to cause the light beams to again penetrate through the light beam penetrating portions; and comparing the intensities of the light beams having again penetrated the light beam penetrating portions to detect defects of the phase shifting mask; and
a second step of injecting the light beams into a third and a fourth light beam penetrating portions having a second phase of the phase shifting mask, reflecting the light beams having penetrated the light beam penetrating portions, by use of reflecting means, to cause the light beams to again penetrate through the light beam penetrating portions; and comparing the intensities of the light beams having again penetrated the light beam penetrating portions to detect defects of the phase shifting mask.

3. The method for defect inspection of a phase shifting mask according to claim 2, wherein the first step and the second step are alternately repeated.

4. The method for defect inspection of a phase shifting mask according to claim 3, wherein operation of the alternate repeating is a move of the phase shifting mask or a move of the light beam having the predetermined intensity.

5. The method for defect inspection of a phase shifting mask according to claim 2, wherein the first phase is 0° and the second phase is 180°.

6. A method for defect inspection of a phase shifting mask, comprising:
a first step of causing a light beam having a predetermined light beam intensity to penetrate through a normal portion having a first phase of the phase shifting mask, reflecting the light beam having penetrated the penetrating portion, by use of reflecting means, to cause the light beam to again penetrate through the normal portion having the first phase, and measuring in advance the intensity of the light beam having again penetrated as a reference intensity; and
a second step of causing the light beam to penetrate through a defect uninspected portion having the first phase, reflecting the light beam having penetrated the uninspected portion, by use of reflecting means, to cause the light beam to again penetrate through the uninspected portion, and comparing the intensity of the light beam having again penetrated through the uninspected portion with the reference intensity, to thereby detect defects.

7. An apparatus for defect inspection of a phase shifting mask, having;
an optical system which includes;
a light source having a predetermined light beam intensity;
a light beam injecting unit for injecting a light beam from the light source into a light beam penetrating portion of the phase shifting mask;
a light beam reflecting unit for reflecting the light beam having penetrated the light beam penetrating portion, to cause the light beam to again penetrate through the light beam penetrating portion; and
a light beam detection unit for detecting the intensity of the reflected light beam; wherein
the apparatus comprising a comparing circuit for comparing the detected intensities of the light beam.

8. The apparatus for defect inspection of a phase shifting mask according to claim 7, wherein the apparatus is provided with at least two systems of the light beam injecting unit, the light beam reflecting unit and the light beam detection unit.

9. The apparatus for defect inspection of a phase shifting mask according to claim 7, wherein the light beam detection portion comprises an image detecting device and an image amplifying circuit.

10. The apparatus for defect inspection of a phase shifting mask according to claim 7, wherein the apparatus is provided with a single system of the light beam injecting unit, the light beam reflecting unit and the light beam detection unit.
